(19) United States
(12) Patent Application Publication
(10) Pub. No.: US 2012/0005044 A1
(43) Pub. Date: Jan. 5, 2012

(54) System And Method To Provide A Table Of Products Based On Ranked User Specified Product Attributes

(75) Inventor: Greg Coleman, San Francisco, CA (US)

(73) Assignee: CBS Interactive, Inc., San Francisco, CA (US)

(21) Appl. No.: 12/828,165

(22) Filed: Jun. 30, 2010

(51) Int. Cl. G06Q 30/00

(52) U.S. Cl. 705/27.2

(57) ABSTRACT

A system and method to provide a table of product attributes based on user specified preferences. A database module that stores an electronic catalog of products is utilized. The electronic catalog includes a taxonomy of products, categories, and products within the categories. The catalog also includes product attributes which describe products in a category which have at least one value for the product attributes. A user interface module displays a table that compares products having at least one common product attribute. The user interface module receives user selected product attributes and relative product rankings two or more of the user selected product attributes. A query module is provided this information and identifies products from the stored electronic catalog which have at least one of the user selected product attributes. The user interface module displays the identified products in the table in an order based on their relative product attribute rankings.

### BACKGROUND

1. Technical Field

The present disclosure relates to a system and method to provide a table of products based on ranked user specified product attributes

2. Description of the Related Art

Many websites are configured as online catalogs. These catalogs act as alternatives to traditional paper catalogs and offer enhanced navigational features when compared to their paper counterparts, as well as the advantages of broad, easy distribution. With the advent and increasing popularity of the Internet, suppliers have access to a much larger customer base. Through the Internet, the market base of manufacturers and resellers may be maximized while the associated overhead may potentially be drastically reduced. If an electronic catalog is well-organized and presented, it can help consumers to make good purchasing decisions by providing extensive information about the products they contain in an easy-to-navigate manner. Such a catalog either allows the consumers to gain information about products they will purchase elsewhere or to make purchases within the site itself. Additionally, such a catalog serves as a site where companies may purchase advertising to market their products.

Such electronic catalogs generally store, in a database, information about a number of products which may be anything from electronics to housewares to apparel, or any other type of item which may be depicted and/or described electronically. Such items may be described by a taxonomy, which describes the set of products with a set of information that consists of a set of attributes that assume values. That is, each product might be associated with a price, brand, or other attribute. Some attributes would only be stored for some classes of product. For example, weight might be a attribute with respect to laptops, but not desktop computers, while both might have a processor speed attribute.

Once a retailer or other content provider has provided a taxonomy for its products, it remains for the users of the catalog system to retrieve the products using the taxonomy system.

One way to do this is by performing searches using filters. These filters are composed of individual filter parameters, which are rules which narrow the selection of products in a taxonomy according to some criterion. Such filters constrain the allowable values of the attributes, and thereby generate a more manageable subset of the products that the user may use, manipulate, and digest. Together, a set of filter parameters forms a filter parameter set, which represents a progressively narrowed selection of filter parameters. An example filter parameter set would be that if a user were searching for digital cameras, the user might want cameras from Canon™, which are 6 megapixels or greater, and which are under $300 in price. A filter parameter set further consists of the individual, discrete filter parameters, which limit the user's search in a progressive manner. Each filter parameter imposes a constraint on one or more product attributes at a time.

Filters allow the users to reduce the potentially huge numbers of products which otherwise occupy catalogs and reduce them to a manageable numbers. They also allow users to focus their searches to meet their individualized needs, as well as incorporating factors such as ability to pay or brand requirements due to purchasing contracts.

### SUMMARY

In an aspect, a computer system is configured to provide a table of product attributes based on user specified preferences. The computer system comprises a database module that is configured to store an electronic catalog of products. The electronic catalog comprises a taxonomy of products, categories, and products within the categories along with product attributes which describe products in a category and at least one value for the product attributes. A user interface module is configured to display a table comparing products having at least one common product attribute and receive a plurality of user selected product attributes and a relative product ranking of at least two of said user selected product attributes. The user interface module being executed by one or more processors. A query module is configured to receive the user selected product attributes from the user interface module, wherein the query module queries the database module to identify a plurality of products from the electronic catalog which have at least one of the user selected product attributes. The user interface module displays the identified products in the table in an order based on the relative product attribute ranking.

In an aspect, the present disclosure describes a method of providing a table of product attributes based on user specified preferences. The method comprises operating a database module using a processor, to store an electronic catalog of products. The electronic catalog comprises a taxonomy of products, categories, and products within the categories. The electronic catalog further comprises product attributes which describe products in a category and at least one value for the product attributes. The method comprises receiving a plurality of user selected product attributes and a relative product ranking of at least two of said user selected product attributes. The method includes querying the database module to identify a plurality of products from the electronic catalog which have at least one of the user selected product attributes. The method includes displaying, via the user interface module, the identified products in the table in an order based on the relative product attribute ranking received by the user interface module.

In an aspect, the present disclosure describes computer readable media which has instructions stored thereon. The instructions, when executed by a computer processor, perform a method of providing a table of product attributes based on user specified preferences. The instructions are for operating a database module configured to store an electronic catalog of products. The electronic catalog comprises a taxonomy of products, categories, and products within the categories. The electronic catalog further comprises product attributes which describe products in a category and at least one value for the product attributes. The instructions are also for receiving a plurality of user selected product attributes and a relative product ranking of at least two of said user selected product attributes. The instructions are also for querying the database module to identify a plurality of products from the electronic catalog which have at least one of the user selected product attributes. Additionally, the instructions are for displaying, via the user interface module, the identified products in the table in an order based on the relative product attribute ranking received by the user interface module.

### BRIEF DESCRIPTION OF THE DRAWINGS

FIG. 1 is a diagram illustrating the interactions between the components of a system aspect in accordance with the present disclosure.

FIG. 2 is a diagram illustrating a taxonomy in accordance with system in which the present disclosure may be implemented.

FIG. 3 is a screenshot of an catalog in accordance with the present disclosure depicting a front-page for category selection.

FIG. 4 is a screenshot of an catalog in accordance with the present disclosure depicting a page where the cell phone category has been selected.

FIG. 5 is a screenshot of an catalog in accordance with the present disclosure depicting a page where AT&T™ cell phones have been selected.

FIG. 6 is a screenshot of an catalog in accordance with the present disclosure depicting a AT&T™ cell phones selling for between $50-$100 have been selected.

FIG. 7 is a screenshot of an catalog in accordance depicting a AT&T™ cell phones selling for between $50-$100 made by Sony Ericsson™ have been selected.

FIG. 8 is a flowchart illustrating the method performed by the system according to an aspect of the present disclosure.

FIG. 9 is a mock display of recorded filter parameter logs and conclusions reached by an aspect of the present disclosure.

FIG. 10 is a sample set of line graphs produced by an aspect of the present disclosure.

FIG. 11 is a sample set of line graphs produced by an aspect of the present disclosure contained in a pop-up window set above a view of a list of products from the catalog.

FIGS. 12A-12B illustrates an example set up screen and customizable product comparison table in accordance with an aspect of the present disclosure.

FIG. 13 illustrates a method performed by the system in relation to the customizable product comparison table according to an aspect of the present disclosure.

### DETAILED DESCRIPTION

Example embodiments are described herein in the context of a system of computers, servers, and software. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. It is understood that the phrase “an embodiment” encompasses more than one embodiment and is thus not limited to only one embodiment. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Eraseable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

In the following description, numerous specific details are set forth in order to provide a thorough understanding of the present disclosure. It will be apparent, however, to one skilled in the art, that the present disclosure may be practiced without some or all of these specific details. In other instances, well known process steps have not been described in detail in order not to unnecessarily obscure the present disclosure.

Embodiments are described herein that involve a system utilizing catalog data to which is stored and organized in an efficient manner through the use of a taxonomy. The taxonomy categorizes the products by using attributes, where products are associated with one or more values of the attributes. Such attributes describe and organize the products in the catalog for retrieval.

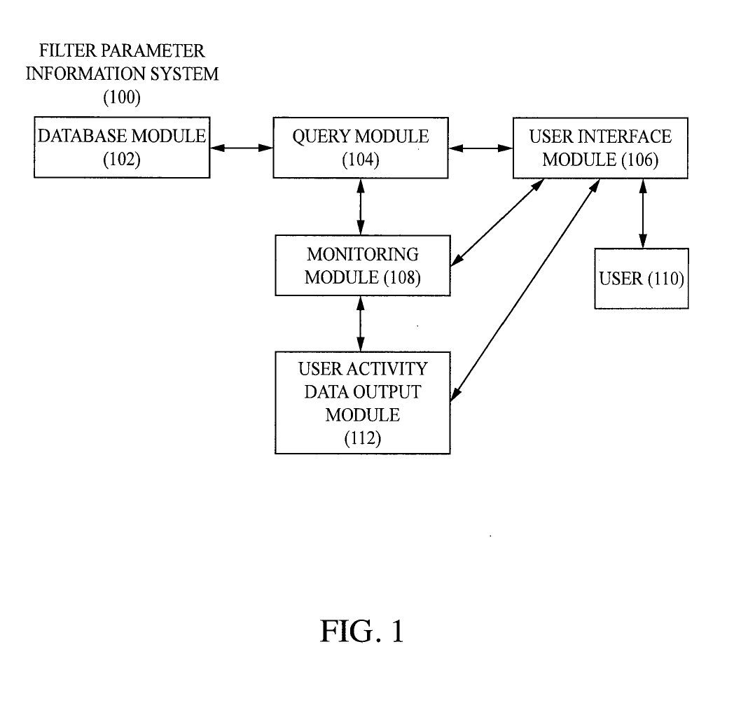

The configuration of the filter parameter information system 100 is characterized in FIG. 1. The catalog is ideally stored in a database module 102. The database may preferably employ a relational model, though it may alternatively employ a flat model, hierarchical model, network model, dimensional model, object model, object-relational model, any combination of the above or other database formats. The database may use a querying language such as SQL to retrieve data internally. Alternatively, the catalog may be stored in another file or collection of files such as a word processing document, or spreadsheet. The catalog information may be stored on a single machine or on multiple machines over a network. The catalog may be accessible over the World Wide Web or over another network though a web browser. In an example, the catalog is accessible directly from a dedicated program where the catalog is stored on a network or locally. The contents of the catalog may be stored upon any tangible medium, such as, but not limited to: magnetic media, optical media, magneto-optical media, solid-state memory, and/or flash memory. The catalog may be stored locally or distributed over a network.

The system's database receives requests from one or more users to access the contents of the catalog from a query module 104, wherein the query module 104 mediates requests which are required by the user interface module 106. The user interface module 106 is displayed on an electronic device having a monitor. The electronic device preferably includes an input device such as a keyboard and mouse to view and/or manipulate information on a Web page, or other GUI interface, but may also involve alternative forms of interaction such as a command line, audio input/output or printed output, or assorted I/O peripherals such as a joystick, gamepad, trackpad, trackball, or other forms of I/O such as those used by the disabled, in order to interact with the users 110 and inform them about the operation of the system and obtain their desired filter parameters. This information flows to and from the user interface module 106 to a monitoring module 108 and a user activity data output module 112. In an aspect, the monitoring module performs computations with respect to the information in the catalog, as will be discussed below. The user activity data output module 112 then presents the results of its computations to the user 110 via the user interface module 106.

Within the catalog, the taxonomy allows the products to be divided into categories of product attributes, whereby one or more of the categories may have its own particular set of subcategories. This categorization exists based on the structure of the attributes that are each associated with a given category of product. As an example, a product category could be computers, which are divided into a first level of product attribute subcategories which can include laptops and desktops and the like. The laptops subcategory can be further subdivided into a second level of product attribute subcategories, such as “netbook”, “thin-and-light”, “mainstream”, and “desktop replacement”. The second level product attribute subcategories can be further subdivided into a third level of product attribute categories such as weight, price (which might be divided by ranges), manufacturer, type of processor and the like. On the other hand, the desktop category might be further subdivided into product attribute categories such as price and type of processor, but might have other product attributes that are specific only to a desktop computer, such as “number of drive bays”. Moreover, certain sublevel product attributes might have multi-leveled product categories. For example, an Intel™ processor product attribute can be divided into subcategories such as “Core 2™ processor”, “Core 2 Duo™ processor” and “Core 2 Quad™ processor”.

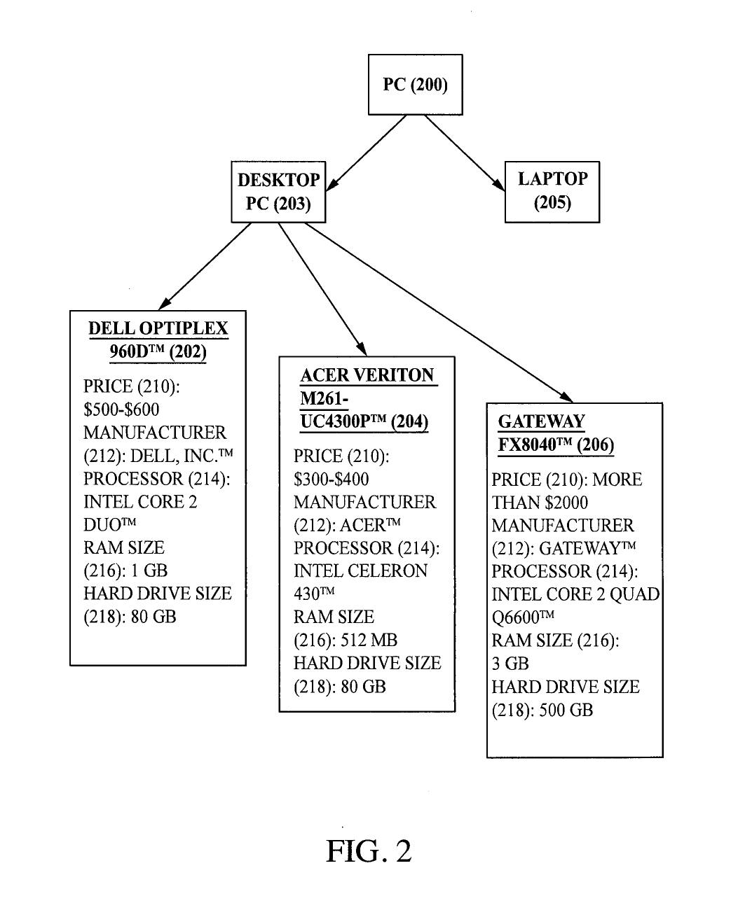

An example taxonomy is presented in FIG. 2, for Desktop PCs. The category of PCs 200 branches into the subcategories of Desktop PCs 203 and Laptop PCs 205. The subcategory for Desktop PCs 203 contains three examples of actual products such as Dell Optiplex 960D™ (202); Acer Vernon M261-UC4300P™ (204); and the Gateway FX8040™ (206). Each of these products has a number of product attributes such as price 210, manufacturer 212, processor type 214, RAM size 216, and hard drive size 218. Clearly, the implementation of such a taxonomy the system will differ by the database model or alternative schema used to store the database in the database module 102. However, given a relational model, such a taxonomy can be easily stored and accessed by the system in an organized manner by assigning each product with a unique product identification (ID). Additionally, a table can be created which associates the unique product identification ID with the relevant attributes, each of which is given a value. However, many alternative embodiments are possible and this merely represents a preferred method of storing the catalog if a relational database management system (RDBMS) approach is chosen.

It is to be noted that the catalog need not represent a set of tangible products represented by nodes within the taxonomy. The catalog may also operate on a digital level and contain items of digital content. These items may contain digital text, audio, MIDI data, recorded audiobooks, digital music, bitmapped and/or vector graphics, digital photographs, video, movies, TV episodes, digital documents, animations, software, web content, multimedia, any form of encoded or archived data, and/or any other type of file or group of files which may be use to store useful computer data. These files may be stored locally or remotely from the web site or other interface shell which is used to allow the user to access the catalog via an electronic device.

In an aspect, a catalog which incorporates one or more of these data types will operate as described below, except that attributes of the one or more data types will reflect characteristics of the type of data involved when using filters instead of characteristics of merchandise. For example, a catalog which contains video products might have attributes such as “length” (which might be various ranges of minutes), “type” (which might be “black-and-white” or “color”, or alternatively might include different levels of color quality), or might involve more qualitative attributes such as “genre” (e.g. action, comedy, drama, science-fiction, western) or “rating” (e.g. a star rating system, a points system). Note that some catalogs will have items in the taxonomy which may reflect pieces of merchandise which are linked to “virtual merchandise”, such as digital media. For example, pieces of digital music might be linked to real-world CD albums on which the songs are located. A system which utilizes such taxonomy will allow the user to make intelligent ad recommendations. For example, the system may provide a filter selection (as described below) which displays songs from a specific artist, as well as albums that are inexpensive. In this example, upon the user selects an album or a song from that artist, the system may be configured to suggest to the user, via advertising, of other inexpensive digital media from that artist that the user would be likely to purchase.

Building upon the catalog, the system allows the products to be searched and information of the products accessed through the use of attributes filters. These attribute filters can include combinations of filter parameters which limit the values assigned to each attribute. These filter parameters include a set of parameters requiring one or more of: a given attribute equals a specific value; a given attribute is not equal to a specific value; a given attribute is greater than a specific value; a given attribute is greater than or equal to a specific value; a given attribute is less than a specific value; a given category value is less than or equal to a specific value; a given attribute falls within a specific interval; a given category value falls outside of a specific interval, or other restrictions on the variables.

The order in which filter parameters are selected may be significant. For example, if the user selects cameras that are 10 megapixels or greater as a first filter parameter, this may lead to available lens types that would not have been available had, for example, the user selected a camera that cost under $50. Also, some heuristics may be used to give weight to the first filters and assume that they are more important to the user.

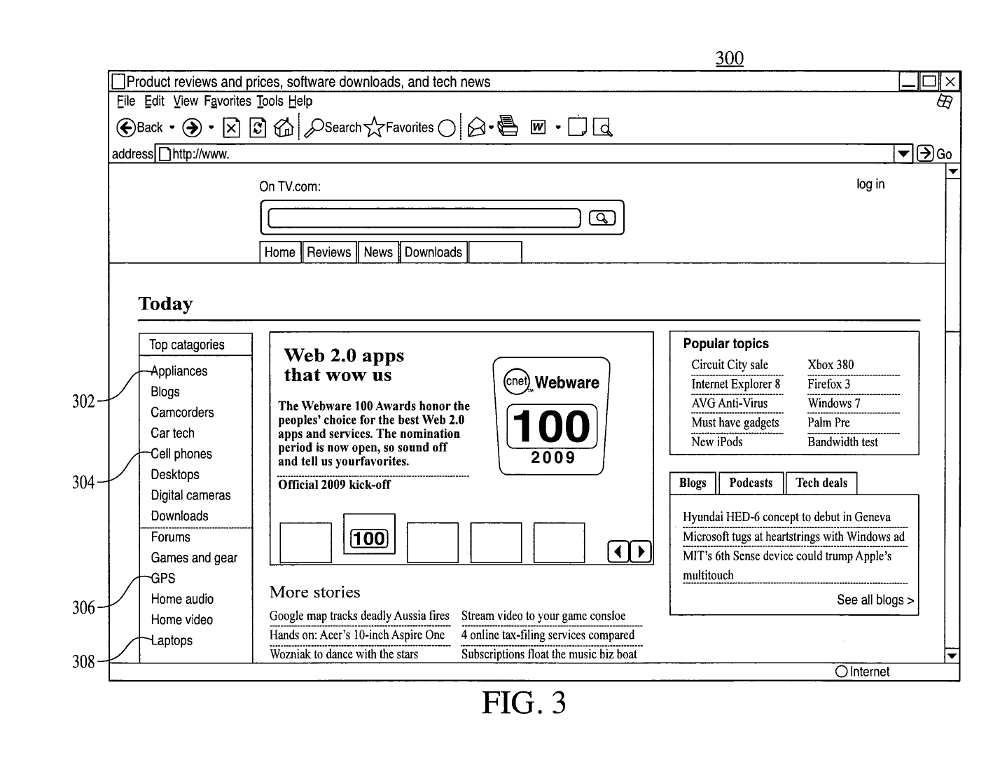

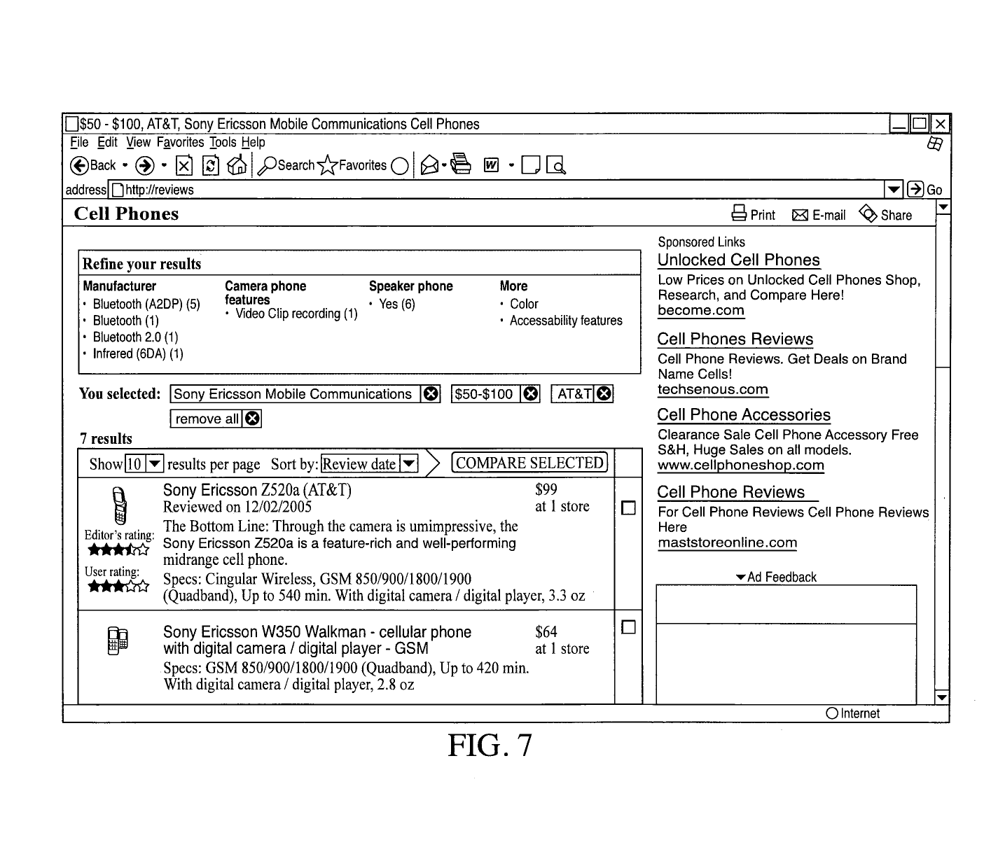

FIGS. 3-7 illustrates various web page screenshots displaying a catalog interface containing an assortment of technology products and associated filter parameters which allow the user to narrow the selection of products under consideration. Furthermore, as will be discussed in more detail below, the system is configured to monitor and store one or more users' choice of filters over time. The system is thus able to provide a pool of data which can then been used as a basis, in combination with a new filter selection, for recommendations of content to the user.

The information shown by the screenshots in FIG. 3-7 is now explained in more detail, as an example of how the user selects filter parameters. FIG. 3 shows a web page 300 of a shopping website, CNET.COM™, which offers access to a catalog of technology products. As will be discussed in more detail, each technology product has multiple attributes associated with it, and whereby one or more of the attributes has a corresponding value. As can be seen on the web page 300 in FIG. 3, some of the product categories which are in the catalog include “Appliances” 302, “Cell Phones” 304, “GPS” 306, and “Laptops” 308, as well as others.

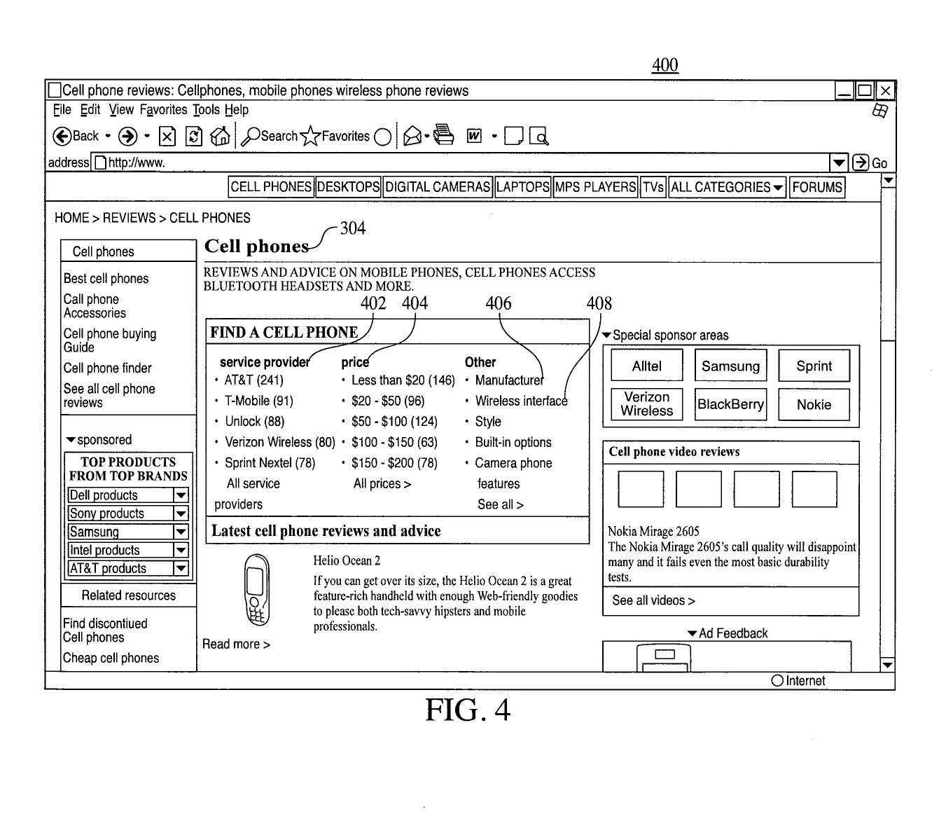

For example, when the user clicks on “Cell Phones” 304 link on the web page 300, the user is brought to a web page as the one shown in FIG. 4. The system then allows the user to navigate the catalog by progressively choosing filter parameters which narrow the selection of cell phones under consideration. As shown in FIG. 4, the system provides the user with several subcategories under the first level category of “Cell Phones” 304. In particular, the system provides the user with several subcategories including “Service Provider” 402, “Price” 404, “Manufacturer” 406, “Wireless Interface” 408, and the like. Continuing with the example, the user may choose to see cell phones whose service provider is AT&T™, and thereby click on the “AT&T™” link 410 on the web page 400.

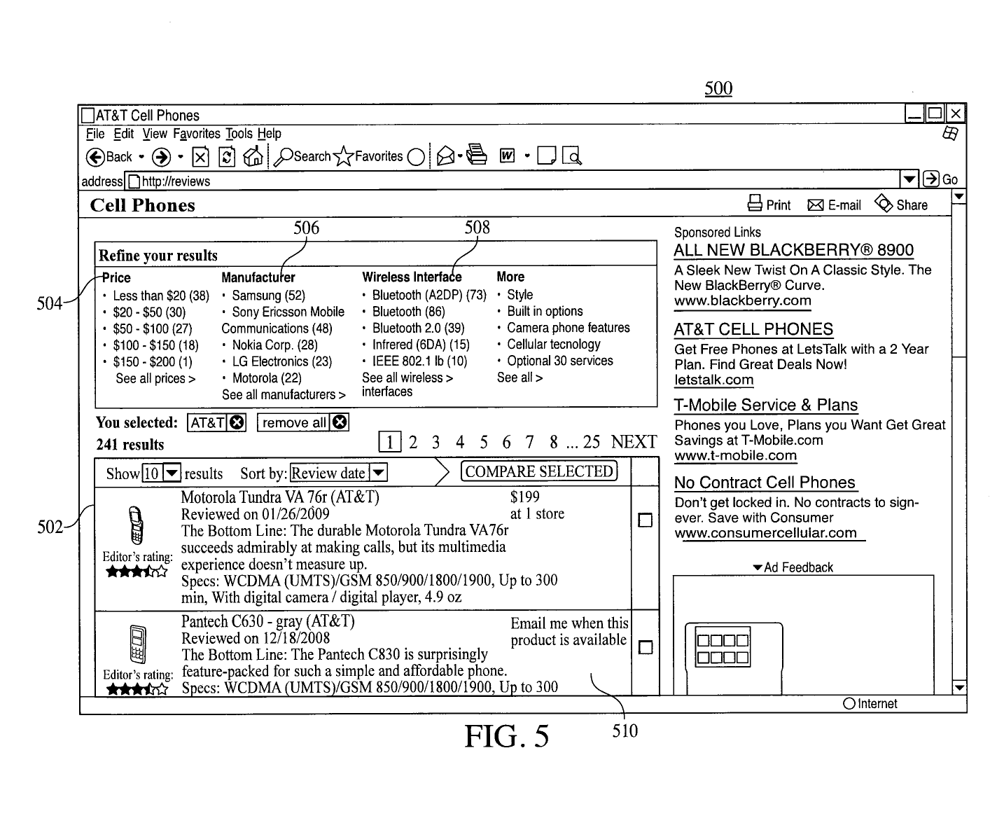

The system, upon receiving the user's input, displays the web page 500 as illustrated in FIG. 5. As shown in FIG. 5, the products under consideration are further restricted to the 241 available cell phones, as shown in the results section 502 on the web page 500, whose associated service provider is AT&T™. At this point, the set of criteria displayed by the system is further narrowed by the filter parameters, such as “Price” 504, “Manufacturer” 506, “Wireless interface” 508, and others. As shown in FIG. 5, the system provides a user window 510 which the user can scroll along to view the 241 phones which are available with AT&T™ being the service provider.

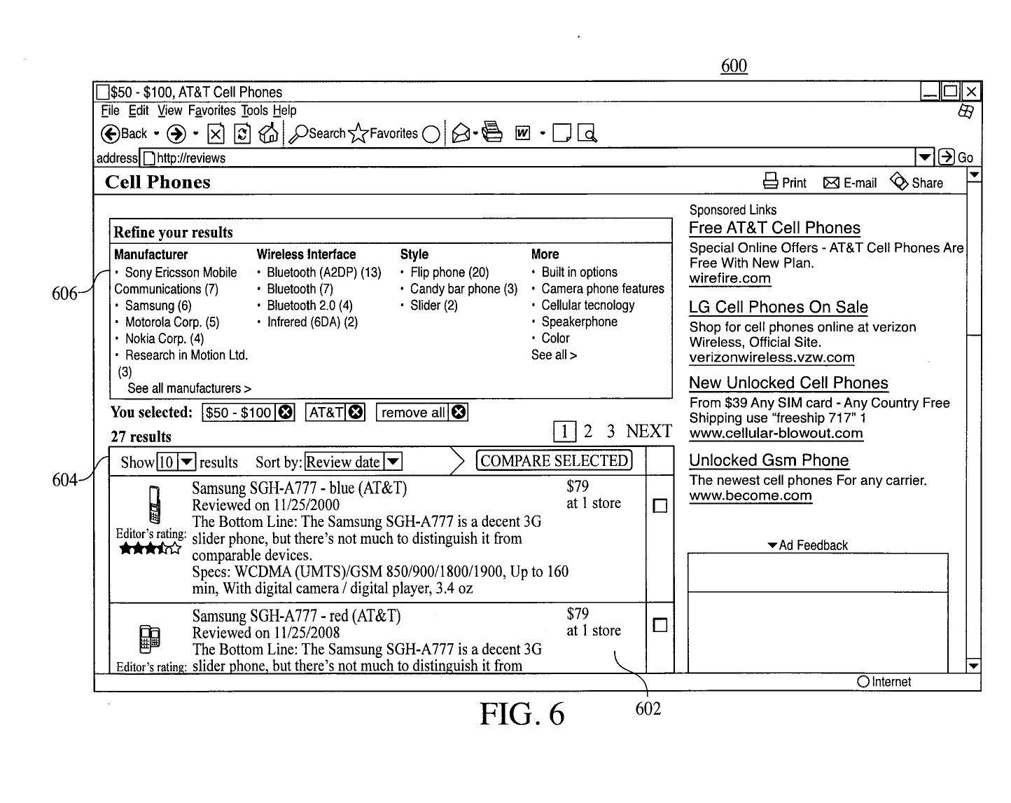

It is to be noted, of course, that the filtering parameters provided by the system is progressive or additive. That is, as the user applies more filtering parameters, the available products are progressively narrowed down based on whether the products have the characteristics that user selected in the filtering parameters. Returning to the example, if the user progressively selects another filter parameter, such as the “Price” 504 link, and in particular, the “$50-$100” link 512, the system will update the displayed catalog to reflect, as in FIG. 6, only those $50-$100 phones that are also designed to have AT&T™ as a service provider. Again, the system provides a user window 602 which the user can scroll along to view the 27 phones, as indicated in the search results section 604, which are available with AT&T™ being the service provider.

Proceeding onwards, the user may select an additional filter, given these two constraints, that the manufacturer of the phone is Sony Ericsson Mobile™ communications, as indicated by the link 606 in FIG. 6. Thus, by the system providing the progressive attribute filters, the user is able to narrow the search set from hundreds of potential cell phones down to a manageable number of cell phones.

As the system allows the user to utilize progressive attribute filters while searching the catalog, it is contemplated that the system monitors attribute filter parameters that one or more users of the catalog system select over a period of time. The system can use the monitoring data to draw inferences about the behavior of one user or an overall group of users who have contributed to a set of filter parameters for the same type of product category (e.g. cell phones) or between different product categories (e.g. cell phones and handsfree phone headsets). Alternatively, the monitoring data gathered by the system may be used for other applications, such as by using text or graphics to summarize or depict the monitored data for one or more users, so that users, advertisers and/or business executives may determine relational conclusions for or between one or more products and/or attributes. Furthermore, the data from monitoring the set of filter parameters may allow the system to adopt a more intelligent approach to the filter interface with the users, in that it may allow the catalog interface to be able to be more or less selective about which filters or how many filters should become displayed to the user for their potential selection at any given time.

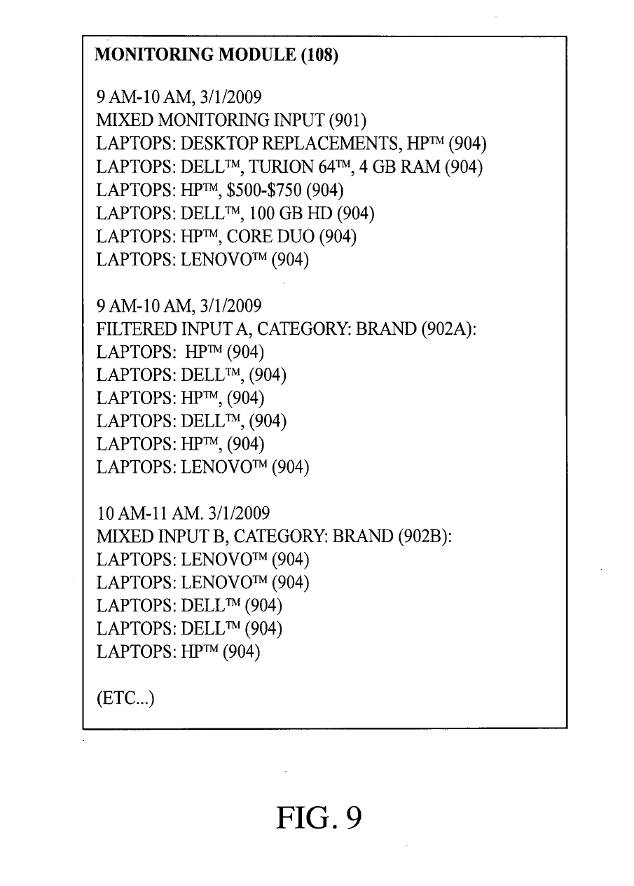

FIG. 9 is a mock display of a recorded filter parameter log in accordance with an aspect of the present disclosure. As shown in FIG. 9, the system is able to display the recorded filter parameter log in accordance with an aspect. The mixed monitoring log 901 may comprise a time-based chronological file of entries indicating products searched by users as well as the attribute filters selected by users for that product. In the example mixed monitoring log shown in FIG. 9, the system displays a sequence of attribute filter parameters selected by one or more users in one search. The mixed monitoring log 901 may be stored in any usable format, but an exemplary format would be to use a text file, and to have one entry per line, with the attribute filter parameters in the attribute filter parameter set separated by commas. The mixed monitoring log 901 stores the complete list of attribute filters on a local or remote memory.

At each stage of the attribute narrowing process, the user is presumed to express a preference about what he or she is interested in based on the attributes selected. By adding a facility to the website which tracks the user's clicks by which he or she progressively selects the attribute filter parameters, the system is able to generate and store potentially useful data of the one or more users, one or more products, and/or one or more product attributes. The user's actions may be captured, for example, if the catalog is accessed via a web page utilizing HTML or XHTML language and the system maintains a set of variables which change based on the user clicking on various attribute filters. Technologies such as JavaScript scripts, Perl scripts, Java applets, JSP, ASP, as well as any other technology known in the art that allows the web page to register a click in a variable, whereby the system's monitoring module 108 tracks, stores and maintains a tally of attribute filter selections within the product taxonomy for further analysis and/or manipulation.

In the preferred embodiment, the monitored information is stored, as noted above in a monitoring log 901, as monitoring log entries 904, but any record of filter parameter selection which allows the system to make inferences based on the filter parameters will be sufficient. The monitoring module 108 processes the information in a mixed monitoring log 901 to yield filtered input 902A and 902B, breaking the overall mixed monitoring log into groups based on time intervals, such as hours that the system is in operation. At this stage of the processing, the individual filter entries are manipulated so that only the entries for the individual categories are present. That is, in the case of 902A, an individual entry 904, Laptops:Dell™, Turion 64™, 4 GB RAM (904), becomes simply Laptops:Dell™.

It is contemplated that the system acquires additional information about which attribute filters are selected as well as the order in which they were selected while the user is perusing the catalog system. The monitoring module 108 may store user click within the taxonomy hierarchy, instead of a mere tally of selections. For example, if the product category that one or more users were searching is MP3 players, the system would track and store how many users selected Sony™ MP3 players as their first choice attribute filter parameter, as opposed to second, third, etc. When the information is processed by the user activity data output module 112, it may graph or otherwise display the data based on this information. Tallying can be also done on the fly to analyze the filter selections from a monitoring log 901. It is to be noted that an actual mixed monitoring log will probably include different filters from multiple categories; FIG. 9 has been simplified for clarity's sake.

This aggregation of filter data is an ongoing process performed by the system, with the system creating a stream of data which is stored in the mixed monitoring log 901, either continuously or at discrete, batched intervals. As the data aggregates into the mixed monitoring log 901, it will also generate sets of inputted attribute filters, such as 902A and 902B. These sets of attribute filtered inputs may be generated such that they are generated for every attribute within the category being analyzed, or they may be generated for a select subset of the categories, or even only one.

Once the filtered input sets, 902A and 902B, have been generated, they can be tallied to generate the number of selections for each attribute filter a desired amount of time. These attribute filter selections may be tracked by individual user selections, in that they are derived from progressive construction of the attribute filter by the addition of filter parameters to the complete attribute filters, and then added to the tallies of the attribute filter parameters in the time intervals. The attribute filter parameters may also be tracked by session, such that totals of the attribute filter selections are generated which compound the totals of how many attribute filter parameters corresponding with each value of each attribute over the course of one login session by a given user.

Once the monitored data of the attribute filter parameters have been tallied, the system can manipulate and process the data to provide feedback using the user activity data output module 112. To begin this process, the monitoring module 108 either transmits the data or allows access by the user activity data output module 112 so that it can provide representations of the data, as well as patterns in the data. These patterns may be both general patterns, as well as patterns that depend upon the specific nature of the attributes involved. They may be recognized by algorithms, heuristics, mathematical analysis, statistical analysis, and/or user inspection of the data. The goal of this manipulation of the data is to generate information by transforming the filter data to yield data that may include summary data, such as text, or alternative graphical depictions of the filter data analysis. This may be performed by the user interface module either on a video monitor, or alternatively it may be provided on a printout.

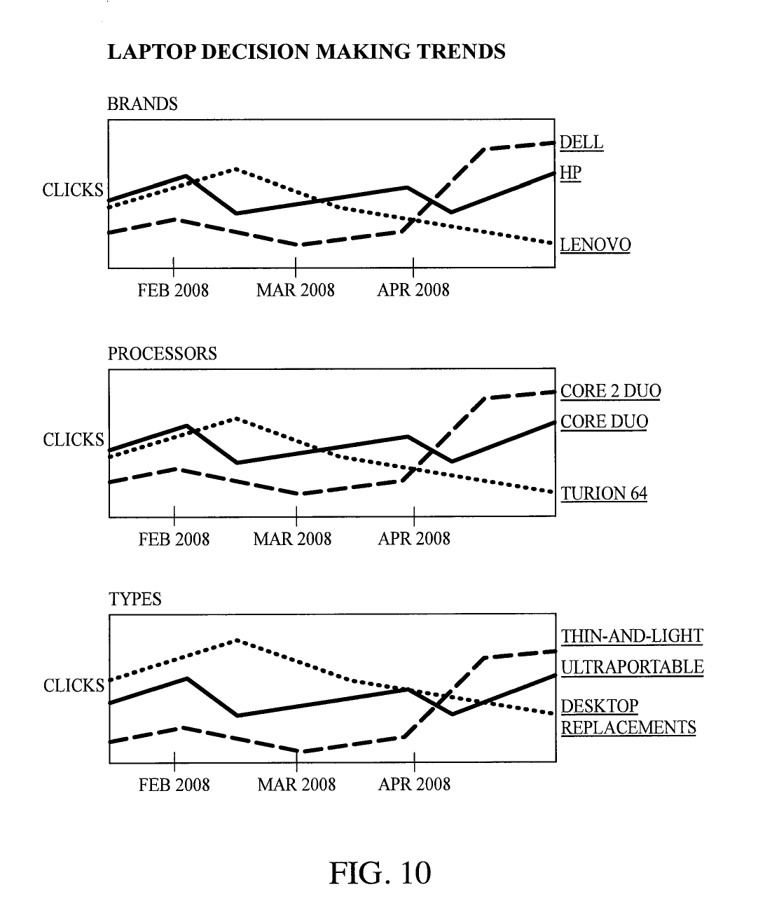

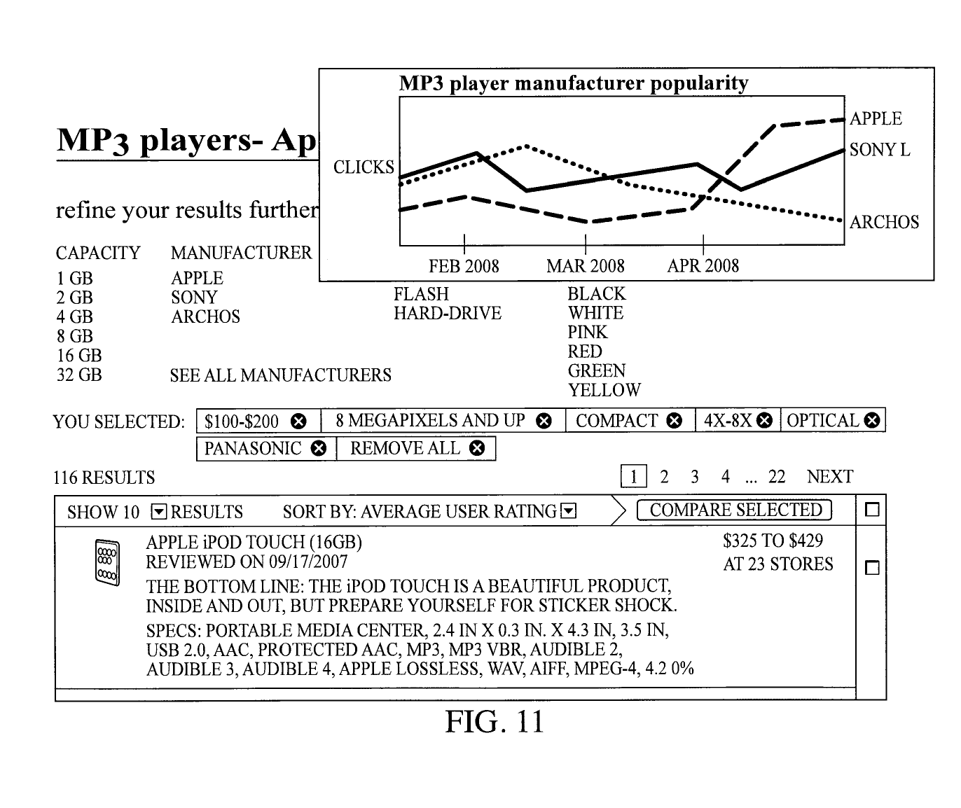

FIGS. 10-11 illustrate samples of graphical depictions of the tallied attribute filter data in accordance with an example. In these figures, line graphs are used to illustrate the data, which includes a set of data points which is illustrative of tallies of attribute filter parameters. However, any other form of graphical depiction which provides a representation of the data may be used to provide the user 110 with insight into the data. More specifically, the data may be represented in a line graph, a bar graph, or a pie chart The graphical depiction may illustrate information as to how the frequency of certain values of the attributes changes over time, or what the total frequencies are over specific time intervals.

The user's 110 ability to manipulate and control the representations which the system presents may be facilitated by various features. For example, the user interface module 108 which presents the graphical depiction may include controls which change the time range depicted. Also, as shown in FIG. 11, the graphical depiction may be presented to the user in a pop-up window. Also as shown in FIG. 11, the system may display the graphical depiction in a subpart of a window which displays a list of products which have one or more attributes which correspond with or fall into the relevant attribute filter parameters. Alternatively stated, the system can concurrently display both the list of products which naturally results from the user's selection of filter parameters through the user's use of the catalog, along with the graphical depiction referred to above which reflects some aspect of overall attribute filter parameter use.

The system may also allow flexible control over the graphical display, such that the user activity data output module possesses control which allow the user to selectively exclude and include one or more user-determined values of said categories and/or attributes from the graphical depiction. This can be done by simply processing through the data, using a Boolean test to filter out the extraneous data, and then graphing the remaining data.

It is also contemplated that the system may embed a hyperlink in one or more attribute filter parameters or attribute values depicted in the graphical depiction which can be used to search the catalog. That is, if a graphical depiction includes lists of specific hyperlinked attribute values, such as “Dell™”, “HP™”, and “Lenovo™”, as in FIG. 10, the system can generate a search page, as shown in FIG. 3, upon the user selecting one of the brands links. The attributes used to categorize the products or items in the catalog may be of any type that is appropriate for a given set of products.

As stated above, the system has the ability to analyze the attribute filter parameter information monitored by the system. In an aspect, the system receives the attribute filter selections relevant to a given attribute for a given time interval. The system analyzes this received data and provides a set of proportions for each value of the attribute, determined over the set of possible values, received for that time interval.

For example, the category that the user searches, and which is tracked by the monitoring module 108, is televisions. In this example, the system monitor which brands of television had been selected for use as attribute filter parameters. In the example, the system determines that over a 3-month period, 12% of users selected the Sony™ attribute filter for televisions, whereas 35% of users selected Panasonic™, 13% selected Sharp™, and 40% selected Samsung™. The system may display this information a pie chart or be analyzed and manipulated in other ways. In an example, the system may display Sony™'s attribute filter percentage in the television category in comparison to Sony™ products in another category, like laptops. It is contemplated that these proportions may be expressed as a percent, a decimal fraction, a standard fraction (for example, 234/452 selections) or any other means of expressing a proportion. It may also be desirable to change the time interval which the fractions reflect, and by obtaining a sequence of data points with proportions of this type, it is possible to observe how input has been changing in the system over time. It is noted that the proportion, rather than the absolute number, of filter parameter selections, can vary widely on a daily basis (the system may monitor more user activity at 2 PM rather than 2 AM). Proportions of various values relative to the total usage is a more consistent barometer of usage patterns because it reflects popularity of choices.

An additional way in which the system may obtain useful information from these proportions is to allow the user to request and receive mathematical and/or statistical analyses of information about the proportions. That is, the user may obtain information by the system using any algorithm, formula, heuristic, or other technique that takes the raw data and draws the information in the data together to summarize the data or draw conclusions from it. For example, as noted previously, the proportions may be graphed versus time to show how different specific attribute values have different frequencies. Some basic mathematical techniques that the embodiments may employ may be derivatives to establish rates of change for the data (coupled with curve fitting techniques), integrals to establish overall total popularity over a period of time (coupled with approximation techniques), as well as identification of maximums, minimums, and averages.

The system may also be configured to group the monitored user data, geographic location, IP address, demographics such as age, gender, groupings (such as Macintosh™ users, gamers, business professionals, IT professionals, etc.) and the like. The system may be configured to gather user profile data through a user profile data gathering module which gathers personal information about users, as just outlined and stores data including a link between said personal information with said user activity data. The user activity data output reflects the personal information of at least one user stored in the user profile data gathering module. Optionally, the system may gather such information from the user to aid in the later analysis of the user's filter selections which may be integrated into the web page as a form, or it may take the form of a pop-up box. Alternatively, the system may automatically gather and store information about the user by associating his or her IP address with the monitored activity.

This data may be further used by the system to recommend that the user buy a product from a given category when the user profile data and/or user activity data fall within predefined or user-configurable parameter. Alternatively, the system may make a similar recommendation, but it may be that the user not buy products from a given category. The way in which these recommendations are derived may vary, but one simple way in which they may be derived is to make recommendations for the most popular (or alternatively, top 3, top 5, etc.) choices in terms of filter parameter selection proportion, and not to recommend the least popular (least 3 unpopular, least 5 unpopular, etc.)

It is to be noted that the attribute filter parameters are tracked on the basis of individual user selections. That is, each time an attribute filter parameter is selected, regardless of whether how many attribute filter parameters are involved, the system counts it towards tallies of the various values of the attributes. An alternative approach which may be used is that the system only considers selected attribute filter parameters to a predetermined depth in the taxonomy of a product. For example, the system may be configured to count only the first three sublevels of attribute filter parameters, whereas and the other sublevels are not counted.

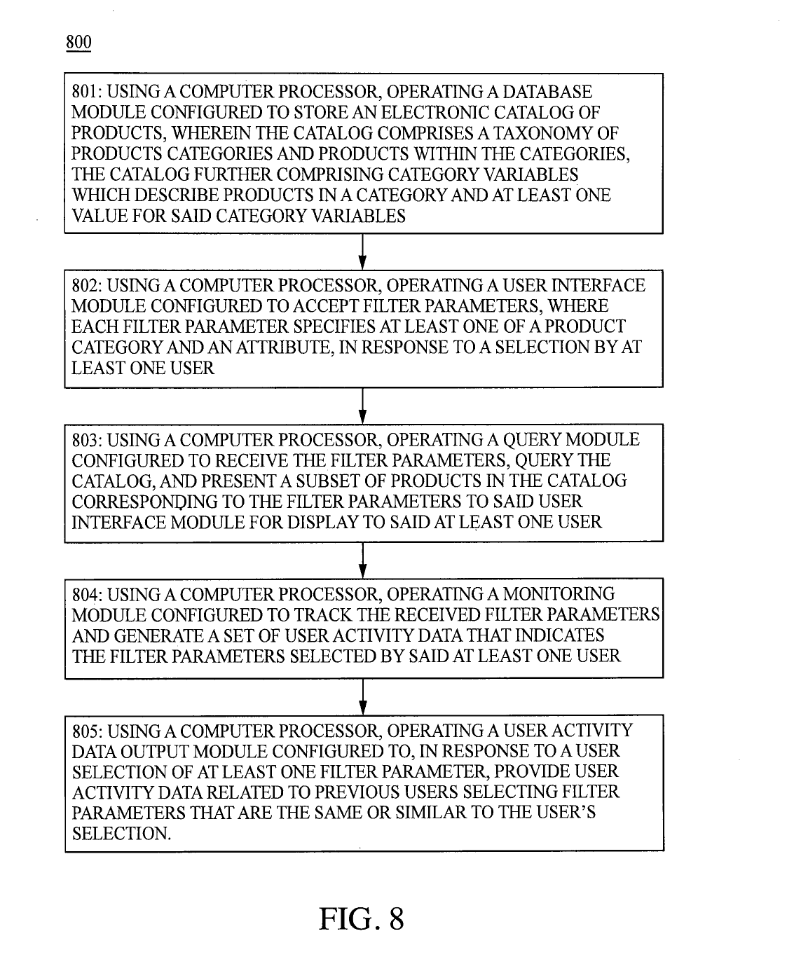

FIG. 8 illustrates an overall process utilized by the system in accordance with an aspect of the present disclosure. As shown, the system can perform a method 800 operating a database module configured to store an electronic catalog of products, wherein the catalog comprises a taxonomy of products categories and products within the categories. The catalog further comprises attributes which describe products in a category and at least one value for the attributes 801. The system utilizes a user interface module that is configured to accept filter parameters, where each filter parameter specifies at least one of a product category and an attribute, in response to a selection by at least one user 802. The system utilizes a query module that is configured to receive the filter parameters, wherein the query module queries the catalog, and presents a subset of products in the catalog corresponding to the filter parameters to the user interface module for display. The system utilizes a monitoring module that is configured to track the received filter parameters and generate a set of user activity data that indicates the filter parameters selected by the user 804. The system utilizes a user activity data output module configured to, in response to a user selection of at least one filter parameter, provide user activity data output related to the user activity data related to previous users selecting filter parameters that are the same or similar to the user's selection 805.

Thus, the system allows collection of information about the users' attribute filter preferences which can reflect not only long-term trends in attribute filter selection, but can also analyses of that information as well as various approaches to mining the information and relating it to other real-world factors. In addition to displaying this information, which is novel in itself, the combination of access to this information with the types of visualizations and manipulations outlined above provide a powerful and sophisticated e-commerce tool. The system brings unexpected advantages to the operation of a catalog by providing visual feedback about an unusual source of data and providing the opportunity to manipulate it to obtain insight into an aspect of user behavior that has not been exploited in this way before. The system also offers specific ongoing information about a facet of user preferences that could not otherwise be accessed.

It should be noted that the filter parameter information system 100 is illustrated and discussed herein as having various modules which perform particular functions and interact with one another. It should be understood that these modules are merely segregated based on their function for the sake of description and do not necessarily represent discrete hardware or software code which is stored on a computer-readable medium for execution on appropriate computing hardware such as a processor. In this regard, these modules, units and other components may be hardware and/or software stored on a computer-readable medium for execution on appropriate computing hardware such as a processor may be thus implemented to substantially perform their particular functions explained herein. The various functions of the different modules and units can be combined or segregated as hardware and/or software stored on a computer-readable medium as above as modules in any manner, and can be used separately or in combination.

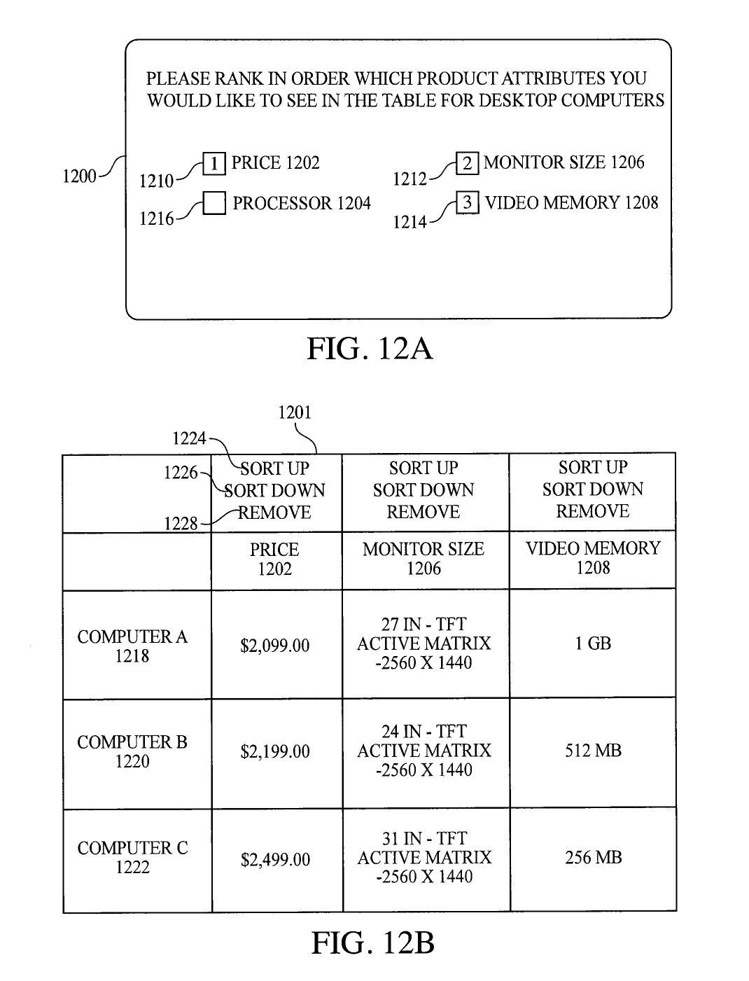

In an aspect, the system is configured to allow the user to create a customizable table which retrieves and displays products that possess user selected product attributes, whereby the products are displayed in an order based on the relative product attributed ranking received by the user interface module. FIGS. 12A and 12B illustrate a product comparison table set up screen and corresponding table in accordance with an aspect of the present disclosure. As shown in FIG. 12A, the system, via a set up screen in the user interface, requests the user to select and rank the product attributes for a particular product category that he or she is interested in.

In the example shown in FIG. 12A, the user is interested in comparing desktop computers, and the set up screen 1200 asks the user to select and rank, in order, the product attributes that are important to the user. In particular, the product attributes shown in the set up screen 1200 are: price 1202, type of processor 1204, monitor size 1206, and video memory 1208. It should be noted that the set up screen 1200 is only an example to explain the novel subject matter and additional and/or other product attributes may be displayed.

As shown in the example in FIG. 12A, the set up screen 1200 has a box next to each product attribute, whereby each box has a fillable field in which the user can rank in order the most important product attribute to the least important product attribute. In particular to the example, the user has placed a “1” in box 1210, which indicates that price is the most important to that user. Additionally, the user has placed a “2” in box 1212, indicating that monitor size 1206 is next in importance. Further, the user has placed a “3” in box 1214, thereby indicating that video memory 1208 is the third important attribute. As shown in FIG. 12A, the user not selected box 1216, thereby indicating that the user does not wish to see processor information in the table 1201 (FIG. 12B).

It should be noted that how the user ranks the product attributes via the set up screen 1200 is only exemplary and other methods of populating the table 1201 are contemplated. For instance, the user can select the product attributes by clicking on a link such as “Add to Comparison Table” or the like. It is also contemplated that the product attributes can be added to the table 1201 by clicking an icon, picture or other designation of the product and dragging it into the table 1201. The ranking order of the attributes may be established by simply allowing the user to drag the attribute and insert it into the desired row or column. For example, once a product attribute is dragged to a new desired location, the data of each product, for the particular attribute, is automatically moved to the new table location.

As shown in FIG. 12B, the table 1201 is displayed to the user, via a user interface, in which the user selected product attributes, Price 1202, Monitor Size 1206 and Video Memory 1208 are arranged along the columns in order of rank (i.e. from left to right) as previously selected by the user. Additionally, the system, upon querying the database containing the electronic catalog, retrieves three computers, Computer A 1218, Computer B, 1220 and Computer C 1222, which possess the product attributes which the user selected and arranges them along the rows in table 1201. In addition, product specific information for each product attribute is placed in the proper cell in the table. For example, for Computer A 1218, the price is shown to be $2,099.00, whereas the monitor size is 27 inches and the video memory size is 1 GB.

It should be noted that only three products (e.g. computers) are shown in the example, and that any number of products can be displayed in the table. Although the product attributes are arranged along the columns and the products are arranged along the rows, it is contemplated that the table 1201 can have an alternative format, whereby the products are arranged in columns and the product attributes are arranged in the rows.

In an aspect, the system can present the order in which the products are displayed based on the values of the product attributes which are most important to the user. For example, in the user ranked price 1202 as the most important attribute. Accordingly, the table 1201 displays the computers based in order of lowest to highest price. In particular, computer A 1218 is arranged in the first row considering that it has the lowest price whereas computer C 1222 is placed in the last row considering that it has the highest price. The system may apply the same logic to the remainder product attributes. For example, the computer A 1218 is placed in first row because it also possess the highest video memory (1 GB) for the price. Further, even though the monitor size 1206 of computer A 1218 is not as large as computer C 1222 (e.g. 31 inches), it is larger than the more expensive computer B 1220 (e.g. 24 inches).

The system also allows the user to manipulate, via the user interface, the order of the product in which they appear in the table 1201 at any time. For example, the user will be able to click on Computer B 1220 and drag it to be above Computer A 1218, whereby the data in each cell, for each product attribute, is automatically updated in its new location. In an aspect, as shown in FIG. 12B, the table 1201 may include a “sort up” link 1224, and “sort down” link 1226 and/or a “remove” link 1228 for each column. Upon the user clicking the “sort up” link 1224 for a particular column (e.g. Price column 1202), the rows of the table 1201 will automatically rearrange to sort the price attributes in an increasingly ranked order. Upon the user clicking the “sort down” link 1226 for a particular column (e.g. Monitor Size column 1206), the rows of the table 1201 will automatically rearrange to sort the monitor size attributes in an decreasingly ranked order. Upon the user clicking the “remove” link 1228 for a particular column (e.g. video memory column 1208), the column will be removed from the table 1201.

The system can also allow the user to save the table 1201 locally on the electronic device or remotely on a server. The system also allows the user to share the table 1201 with other individuals, via email, social networking site (e.g. Facebook™), independent websites (e.g. CNET™) and the like. The rows and/or columns can be also rearranged by those who the user shares the table 1201 with.

Additionally, it is contemplated that products and/or product attributes may be added, removed, and/or rearranged by the receiving individuals. It is contemplated that the system can monitor, via the monitoring module 108 (FIG. 1), the product attributes the user selects as well as the order in which they are placed in the table 1201. This monitoring data can be analyzed by an analyzed to inform advertisers, developers, other users as well as the product manufacturers as to which attributes for a particular product or entire product category are important or not-important to users.

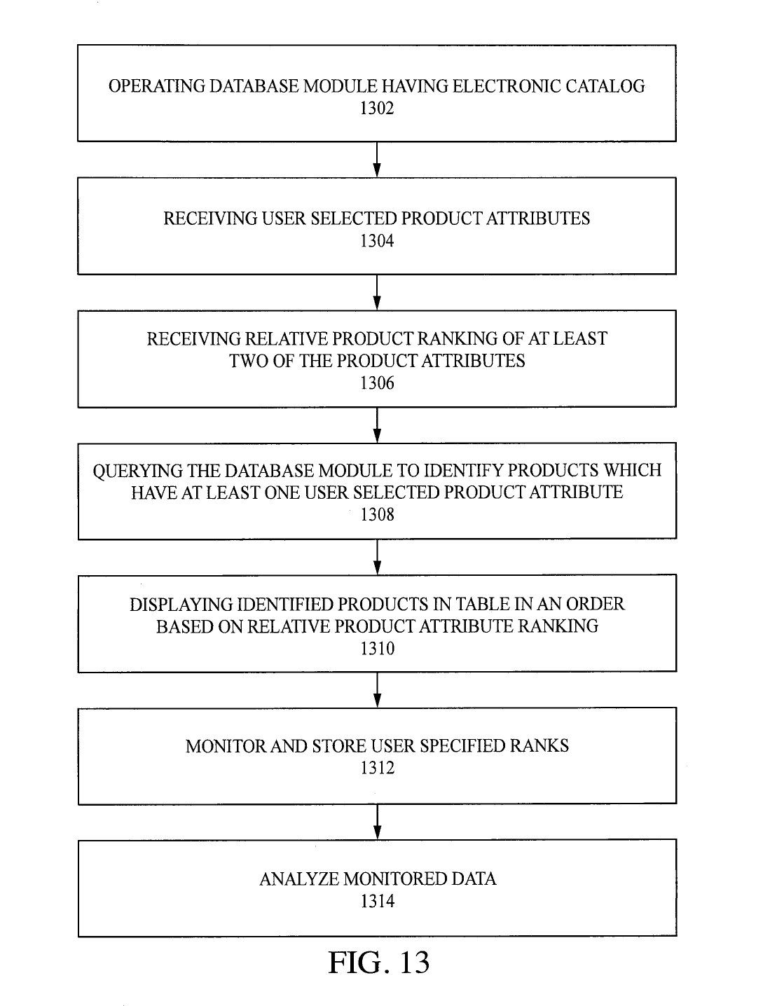

FIG. 13 illustrates a flow chart describing the process of how the table is created in accordance with an aspect of the present disclosure. The system operates a database module having an electronic catalog (block 1302). As describe above, the database module stores an electronic catalog of products, whereby the electronic catalog includes a taxonomy of products, categories, and products within the categories along with product attributes which describe products in a category and have at least one value for the product attributes. The system provides a user interface provided by a user interface module, preferably via a web page, where the module receives a plurality of user selected product attributes (block 1304). In addition, the system receives a relative product ranking from the user of at least two of said user selected product attributes (block 1306). Upon receiving the product attributes and ranks from the user, a query module of the system queries the database module to identify a plurality of products from the electronic catalog which have at least one of the user selected product attributes (block 1308). Thereafter, the system displays, via the user interface module, the identified products in the table in an order based on the relative product attribute ranking received by the user interface module (block 1310). Although optional, a monitoring module monitors the user selected product attributes and the relative product rankings and stores the corresponding monitoring data in a storage medium (block 1312). In an aspect, the monitoring data is analyzed to determine user interest in at least one or more of the product attributes or relative product rankings (block 1314).

While various aspects in accordance with the present disclosure have been shown and described, it is understood not to be limited thereto. The system and method of the present disclosure may be changed, modified and further applied by those skilled in the art. Therefore, the present disclosure is not limited to the detail shown and described previously, but also includes all such changes and modifications.

What is claimed is:

1. A computer system configured to provide a table of product attributes based on user specified preferences, the computer system comprising:
a database module configured to store an electronic catalog of products, wherein the electronic catalog comprises a taxonomy of products, categories, and products within the categories, the electronic catalog further comprising product attributes which describe products in a category and at least one value for the product attributes;
a user interface module configured to display a table comparing products having at least one common product attribute, the user interface module configured to receive a plurality of user selected product attributes and a relative product ranking of at least two of said user selected product attributes, the user interface module being executed by one or more processors;
a query module configured to receive the user selected product attributes from the user interface module, wherein the query module queries the database module to identify a plurality of products from the electronic catalog which have at least one of the user selected product attributes,
wherein the user interface module displays the identified products in the table in an order based on the relative product attribute ranking.

2. The system of claim 1, wherein the relative product attribute ranking is received in response to a click and drag operation performed by a user.

3. The system of claim 1, further comprising:
a monitoring module configured to track the user selected product attributes and the relative product rankings and produce corresponding monitoring data; and
a storage medium configured to store the monitoring data, wherein the monitoring data is analyzed to determine user interest in at least one or more of the product attributes or relative product rankings.

4. The system of claim 1, further comprising a forwarding module configured to forward the table and associated data in the table from a user to one or more recipients, wherein the table is modifiable by the one or more recipients.

5. The system of claim 4, further comprising:
a monitoring module configured to track the selected product attributes and the relative product rankings in the table modified by the one or more recipients, wherein the monitoring module produces corresponding monitoring data; and
a storage medium configured to store the monitoring data, wherein the monitoring data is analyzed to determine user interest in at least one or more of the product attributes or relative product rankings.

6. The system of claim 1, wherein the order of identified products in the table is modifiable to be displayed in an ascending or descending manner.

7. The system of claim 1, wherein the table is stored to a user's account and is retrievable by the user.

8. A method of providing a table of product attributes based on user specified preferences, the method comprising:
using a processor, operating a database module configured to store an electronic catalog of products, wherein the electronic catalog comprises a taxonomy of products, categories, and products within the categories, the electronic catalog further comprising product attributes which describe products in a category and at least one value for the product attributes;
receiving a plurality of user selected product attributes and a relative product ranking of at least two of said user selected product attributes;
querying the database module to identify a plurality of products from the electronic catalog which have at least one of the user selected product attributes; and
displaying, via the user interface module, the identified products in the table in an order based on the relative product attribute ranking received by the user interface module.

9. The method of claim 8, wherein the relative product attribute ranking is received in response to a click and drag operation performed by a user.

10. The method of claim 8, further comprising:
tracking the user selected product attributes and the relative product rankings;
producing corresponding monitoring data which is stored to a storage medium; and
determining user interest in at least one or more of the product attributes or relative product rankings from the monitoring data.

11. The method of claim 8, further comprising forwarding the table and associated data in the table to one or more recipients in response to a user request, wherein the table is modifiable by the one or more recipients.

12. The method of claim 11, further comprising:
tracking the user selected product attributes and the relative product rankings in the table modified by the one or more recipients;
producing corresponding monitoring data which is stored to a storage medium; and
determining user interest in at least one or more of the product attributes or relative product rankings from the monitoring data.

13. The method of claim 8, wherein the order of identified products in the table is modifiable to be displayed in an ascending or descending manner.

14. The method of claim 8, further comprising storing the table to a user's account, wherein the table is retrievable by the user.

15. Computer readable media, having instructions stored thereon, wherein the instructions, when executed by a computer processor, perform a method of providing a table of product attributes based on user specified preferences, the instructions comprising:
instructions for operating a database module configured to store an electronic catalog of products, wherein the electronic catalog comprises a taxonomy of products, categories, and products within the categories, the electronic catalog further comprising product attributes which describe products in a category and at least one value for the product attributes;
instructions for receiving a plurality of user selected product attributes and a relative product ranking of at least two of said user selected product attributes;
instructions for querying the database module to identify a plurality of products from the electronic catalog which have at least one of the user selected product attributes; and
instructions for displaying, via the user interface module, the identified products in the table in an order based on the relative product attribute ranking received by the user interface module.

16. The computer readable media of claim 15, wherein the relative product attribute ranking is received in response to a click and drag operation performed by a user.

17. The computer readable media of claim 15, further comprising:
instructions for tracking the user selected product attributes and the relative product rankings;
instructions for producing corresponding monitoring data which is stored to a storage medium; and
instructions for determining user interest in at least one or more of the product attributes or relative product rankings from the monitoring data.

18. The computer readable media of claim 15, further comprising instructions for forwarding the table and associated data in the table to one or more recipients in response to a user request, wherein the table is modifiable by the one or more recipients.

19. The computer readable media of claim 18, further comprising instructions for tracking the user selected product attributes and the relative product rankings in the table modified by the one or more recipients;
producing corresponding monitoring data which is stored to a storage medium; and
determining user interest in at least one or more of the product attributes or relative product rankings from the monitoring data.

20. The computer readable media of claim 15, wherein the order of identified products in the table is modifiable to be displayed in an ascending or descending manner.

21. The computer readable media of claim 15, further comprising instructions for storing the table to a user's account, wherein the table is retrievable by the user.
